(19) United States
(12) Patent Application Publication
(10) Pub. No.: US 2002/0176737 A1
(43) Pub. Date: Nov. 28, 2002

(54) Securing element for joining two components together

(75) Inventor: Elmar Reineke, Paderborn (DE)

Correspondence Address: Henry M. Feiereisen, Suite 3220, 350 Fifth Avenue, New York, NY, 10118, US

(73) Assignee: BENTELER AUTOMOBILTECHNIK GMBH & CO. KG, Paderborn (DE)

(21) Appl. No.: 10/143,544

(22) Filed: May 10, 2002

(30) Foreign Application Priority Data
May 17, 2001 (DE) 101 23 946.7

(51) Int. Cl. B25G 3/34; F16B 12/04

(52) U.S. Cl. 403/267

(57) ABSTRACT

A securing element for interposition between two components to be joined, includes a double-stick bonding substrate, and plural anchoring bodies adhesively held on the substrate and projecting toward the components. A detachable film is deposited on a bottom side of the substrate whereas a protective film is applied on the topside of the substrate to captivate the anchoring bodies. After removal of the detachable film, the securing element can be adhered to one of the components to be joined, and the two components can then be joined together by pressing them together, whereby the anchoring bodies penetrate into the surface of the components to establish a non-slip connection.

### CROSS-REFERENCES TO RELATED APPLICATIONS

This application claims the priority of German Patent Application Serial No. 101 23 946.7, filed May 17, 2001, pursuant to 35 U.S.C. 119(a)-(d), the subject matter of which is incorporated herein by reference.

### BACKGROUND OF THE INVENTION

The present invention relates to a securing element for joining two components, in particular for motor vehicle components, in fixed rotative engagement.

There are known many different screw locks in the form of spring rings or retainer rings, which are placed underneath a nut to prevent an inadvertent loosening of screw fasteners. Screw locks of this type are provided to compensate creep and settling and to prevent an inadmissible decrease in tension of the connection. However, such screw locks are insufficient to prevent a relative rotation or slipping between the two components that are joined together, especially when the screw is guided with play through the bores of the sheet metal. This is true in the case of assembly as well as in the case of later use, when the components are subjected to greater dynamic loads, in particular vibrations.

In order to prevent translational and rotational movements between joined components or component groups, fastening bodies have been proposed for integration into the joint prior to assembly. When the components to be joined are pressed together, the fastening bodies penetrate their surface. The forced engagement is then converted in this manner in a non-positive and positive connection.

German Pat. No. DE 298 06 800 U1 describes a securing disk for two components to be joined together in fixed rotative engagement. The securing disk includes anchoring bodies in the form of steel balls jutting out in the direction of the components and retained in cutouts of the disk body of the securing disk. When installing the securing disk, the steel balls are forced into the components to thereby realize in addition to a frictional engagement a positive engagement by generating a shearing surface. The securing disk acts hereby as a coupling element which inhibits a relative movement between the components after assembly.

Although this type of securing disk is useful for many applications, the manufacturing process is complicated and a pre-mounting on one of the components is difficult, when the component group is intended for subsequent transport. Moreover, as a consequence of its size, weight, costs, as well as ineffective ball utilization, inflexible geometry and limitations in application, there is much room for improvements of this securing disk.

It would therefore be desirable and advantageous to provide an improved securing element to obviate prior art shortcomings.

### SUMMARY OF THE INVENTION

According to one aspect of the present invention, a securing element for interposition between two components to be joined, includes a bonding substrate, and plural anchoring bodies adhesively held on the substrate and constructed to project out toward the components.

The present invention resolves prior art problems by adhesively securing the anchoring bodies on the substrate. Suitably, the securement of the anchoring bodies is realized by an adhesive. Of course, it is also conceivable to weld the anchoring bodies between films. A securing element according to the present invention can be made in a simple manner and is lightweight as a consequence of the small weight of the bonding substrate. The use of the securing element is possible for a wide variety of applications in a very simple fashion.

According to another feature of the present invention, the substrate may be made of a fabric having two bonding faces coated with an adhesive. Suitably the anchoring bodies are realized by steel balls which may also be hardened depending on the application at hand.

According to another feature of the present invention, there is provided a detachable film provided on one of the bonding faces of the substrate. A protective film may also be provided to cover the bonding face of the substrate confronting the anchoring bodies. The substrate may be further provided with a mounting opening for receiving a connecting element, typically a screw fastener.

The securing element is especially useful as a ball-type sticker made from a double-sided adhesive tape having a detachable film on one side. Balls, in particular steel balls, are bonded onto a bonding face of the adhesive tape and covered by a protective film, which is also joined to the adhesive tape. In this way, the balls are trapped between the protective film and the substrate.

When used, the detachable film is removed, and the securing element is stuck onto the surface of one of the components to be joined. The components or component groups may be joined together immediately or also at a later time, e.g., through bolting. Hereby, the balls are forced into the surfaces of the components to produce a non-slip connection of the components. Penetration of the anchoring bodies into the components can proceed until the components abut one another. As the substrate is fairly thin and also compressible, the gap is very slight.

Costs for tools, plants and utilized machines as well as assembly are slight for the securing element according to the present invention when compared to conventional securing disks and other joining processes. Almost the entire surface of the individual balls is useful as effective surface in order to prevent translational movements. This would not be the case, when the balls are held in a thicker disk body. When applying a connection force, the balls are forced deeper automatically into the one component that is made of softer material. This effect is advantageous because the balls provide in the softer material a greater reactive area against a translational movement.

Size, number, disposition and mechanical properties of the balls used as anchoring bodies can be suited easily to the application at hand, without any need to modify the components or component groups to be joined.

The balls establish a component securement, which absorbs translational forces regardless of their direction. A securing element according to the present invention can be pre-mounted, without need for separate tools or mechanical operations. As the securing element self-adheres to the component, the assembly is simple and efficient. The use of a securing element according to the present invention is very flexible. For example, when it is determined during large-scale fabrication that an additional securement between the components is necessary, the securing element according to the invention can easily be employed for that purpose, without requiring any alterations to the plant.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a fragmentary side view of a securing element according to the present invention; and

FIG. 2 is a plan view of a securing element according to the present invention.

### DETAILED DESCRIPTION OF PREFERRED EMBODIMENTS

Throughout all the Figures, same or corresponding elements are generally indicated by same reference numerals.

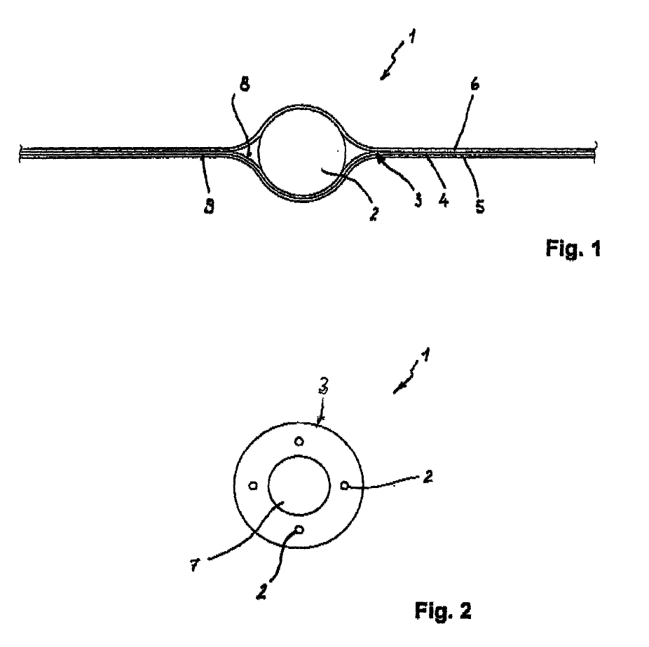

Turning now to the drawing, and in particular to FIG. 1, there is shown a fragmentary side view of a securing element according to the present invention, generally designated by reference numeral 1 and configured as a ball-type sticker. The securing element 1 is used as intermediate layer between two components to be joined together so as to be secured against rotation and against slip. The components are not shown in detail here and may involve, for example, a floor of a motor vehicle and an axle support, respectively.

The securing element 1 includes a bonding substrate 3 and a plurality of positive-locking or anchoring bodies in the form of balls 2 which are secured through adhesion, e.g. by glue or adhesive, to the substrate 3. Currently preferred is the use of steel balls 2. The substrate 3 may be made form a fabric 4 which has opposite bonding faces 8, 9 coated with an adhesive. The bottom bonding face 9 of the substrate 3 in FIG. 1 is provided with a peel-off or detachable film 5, whereas the top bonding face 8 of the substrate 3 is covered by a protective film 6 which also wraps the steel balls 2. The substrate 3 is further provided with a mounting opening 7 for receiving, for example, a screw fastener (not shown).

In the nonlimiting example of FIG. 2, the securing element 1 has four steel balls 2 which are evenly spaced apart along a partial circle in 90° offset disposition.

When mounting the securing element 1, the detachable film 5 is removed and the securing element 1 is adhered onto one of the components to be joined. The mounting opening 7 is hereby in alignment with a mounting opening of this component. Both components are then joined together. When bracing the components together by a connection element, for example a screw fastener (not shown), the components are pulled together, whereby the steel balls 2 penetrate partially into the surface of the components by forming depressions therein. In this way, a positive engagement between the components is established through interposition and integration of the securing element 1. Under normal operating conditions, rotation of the joined components relative to one another is precluded once the securing element 1 is in place between the components, as described.

Manufacture of a securing element 1 in the form of a ball-type sticker involves the use of a double-sided adhesive tape as bonding substrate 3, which can be reeled off from a drum (not shown) intermittently and guided with its bonding face 8 directed upwards over a suitable support. The lower bonding face 9 is hereby covered by the detachable film 5. At each cycle, the desired number of steel balls 2 is placed onto the bonding face 8. If necessary, the steel balls 2 are pressed onto the bonding face 8 to sufficiently hold them in place. Suitable sensors, not shown, may be used to monitor this step to ensure that the required number of steel balls 2 is applied.

Next in the further manufacturing process is the application of the protective film 6 which is also reeled off a drum and pressed onto the upper bonding face 9 of the double-sided adhesive tape that forms the substrate 3. As a result of the deposition of the protective film 6, the steel balls 2 are trapped and captivated. Subsequently, the individual securing elements (ball-type stickers) 1 are stamped out of the sheet or perforated and wound up.

Suitably, the fabrication of the individual securing elements 1 is such that the detachable film 5 can easily be removed, e.g., by a peel-off device from which the detachable film 5 can be manually grasped and pulled off from the securing element 1. Then, the securing element 1 is attached to one of the components.

While the invention has been illustrated and described as embodied in a securing element for joining two components together, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A securing element for interposition between two components to be joined, comprising a bonding substrate; and plural anchoring bodies adhesively held on the substrate and constructed to project toward the components.

2. The securing element of claim 1, wherein the substrate is a fabric having two bonding faces coated with an adhesive.

3. The securing element of claim 1, wherein the anchoring bodies are steel balls.

4. The securing element of claim 2, and further comprising a detachable film provided on one of the bonding faces of the substrate.

5. The securing element of claim 1, and further comprising a protective film for covering the anchoring bodies.

6. The securing element of claim 1, wherein the substrate is provided with an mounting opening.

7. A securing element for joining two components, comprising a substrate having opposite bonding faces; and an anchoring body adhesively held on the substrate and constructed to project from the bonding faces toward the components.

8. The securing element of claim 7, wherein the bonding faces are coated with adhesive.

9. The securing element of claim 7, wherein the anchoring body is a steel ball.

10. A securing element for joining two components, comprising:
a substrate having opposite bonding faces;
an anchoring body;
a detachable film provided on one of the bonding faces of the substrate; and
a protective film applied on the other one of the bonding faces and placed over the anchoring body to so adhesively captivate the anchoring body to the substrate as to project from the bonding faces toward the components.

11. A method of making a securing element useful for joining two components, comprising the steps of:
intermittently moving a tape-like substrate, having two adhesive bonding faces, along a transport path;
depositing a detachable film on one bonding face of the adhesive tape;
placing at least one steel ball on the other bonding face at each cycle;
applying a protective film onto the other bonding face to captivate the steel ball on the substrate.

12. A method of joining two components, comprising the steps of:
attaching an adhesive bonding face of a securing element to a first component;
placing a second component over the securing element in confronting relationship to the first component; and
moving the first and second components against one another to thereby force anchoring balls of the securing element into confronting surfaces of the first and second components to realize a non-slip connection of the components in fixed rotative engagement.
